(19) United States
(12) Patent Application Publication
(10) Pub. No.: US 2013/0089845 A1
(43) Pub. Date: Apr. 11, 2013

(54) AUDIO LINKING OF MOTION TRAINING SESSIONS

(71) Applicant: IKKOS, LLC, Seattle, WA (US)

(72) Inventor: Sean Hutchison, Seattle, WA (US)

(73) Assignee: IKKOS, LLC, Seattle, WA (US)

(21) Appl. No.: 13/647,352

(22) Filed: Oct. 8, 2012

Related U.S. Application Data
(60) Provisional application No. 61/544,495, filed on Oct. 7, 2011.

(51) Int. Cl. G09B 19/00

(52) U.S. Cl. 434/257; 434/247

(57) ABSTRACT

A system and method for training a student to perform bodily movements are disclosed. A model video example of the bodily motion is displayed to the student, which is followed by a sensory-reduced session. During this session, sensory stimulus perceivable by the student is suppressed, to facilitate focus on, attention to, and cognitive absorption of the bodily motion. Audio content is played during the display and sensory-reduced session. The selection and playing of the audio content during the video display and sensory-reduced session are configured to induce the student to cognitively absorb the model video example.

### CROSS REFERENCE TO RELATED APPLICATION

The present application claims the benefit of and priority to U.S. Provisional Application No. 61/544,495 filed Oct. 7, 2011 the content of which is incorporated herein by reference for all purposes.

### BACKGROUND

A variety of methods exist for training individuals to perform bodily motions. Individuals often will watch bodily motions being performed by another, for example an instructor or another expert at the motion. The trainee then attempts to replication that motion. In some cases, their attempts are recorded using video or other means. In any case, the trainee's performance is reviewed to assess whether and to what extent it varied from the motion as demonstrated (e.g., by the instructor). This assessment is used to guide improvement in successive practice attempts.

The above method is often quite effective at teaching the bodily motion, but it is time-consuming and there is always a desire that the improvements be greater and occur sooner. One reason for the limitation is simply that it takes a lot of time and practice for the trainee to truly “feel” the motion with their body in a way that allows “muscle memory” to effectively take over and produce an optimal result. Also, the nature of the feedback, which often is in the form of verbal instructions or additional demonstrations, is limited in its capacity to rapidly produce significant improvements.

### BRIEF DESCRIPTION OF THE DRAWINGS

FIG. 1 depicts an exemplary system for training bodily motions.

FIG. 2 depicts an exemplary method for training bodily motions.

FIGS. 3-6 depict model video examples of a bodily motion, along with recordings of a student's attempt to perform the bodily motion.

FIG. 7 depicts an exemplary method for training bodily motions using stimulation applied to various body parts.

FIG. 8 depicts a student engaged in body-stimulation motion training

### DETAILED DESCRIPTION

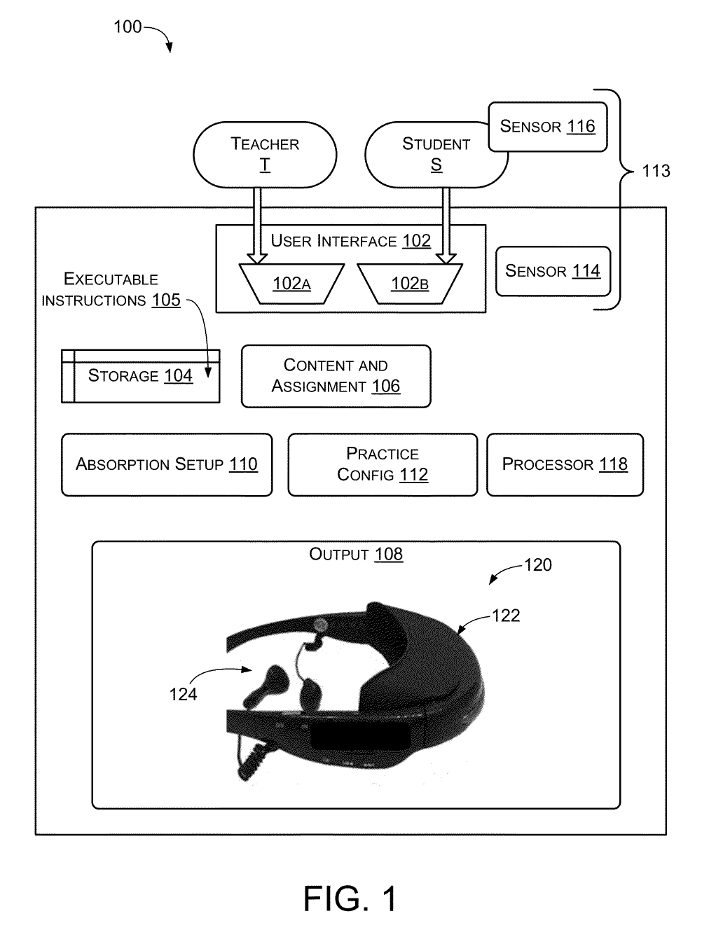

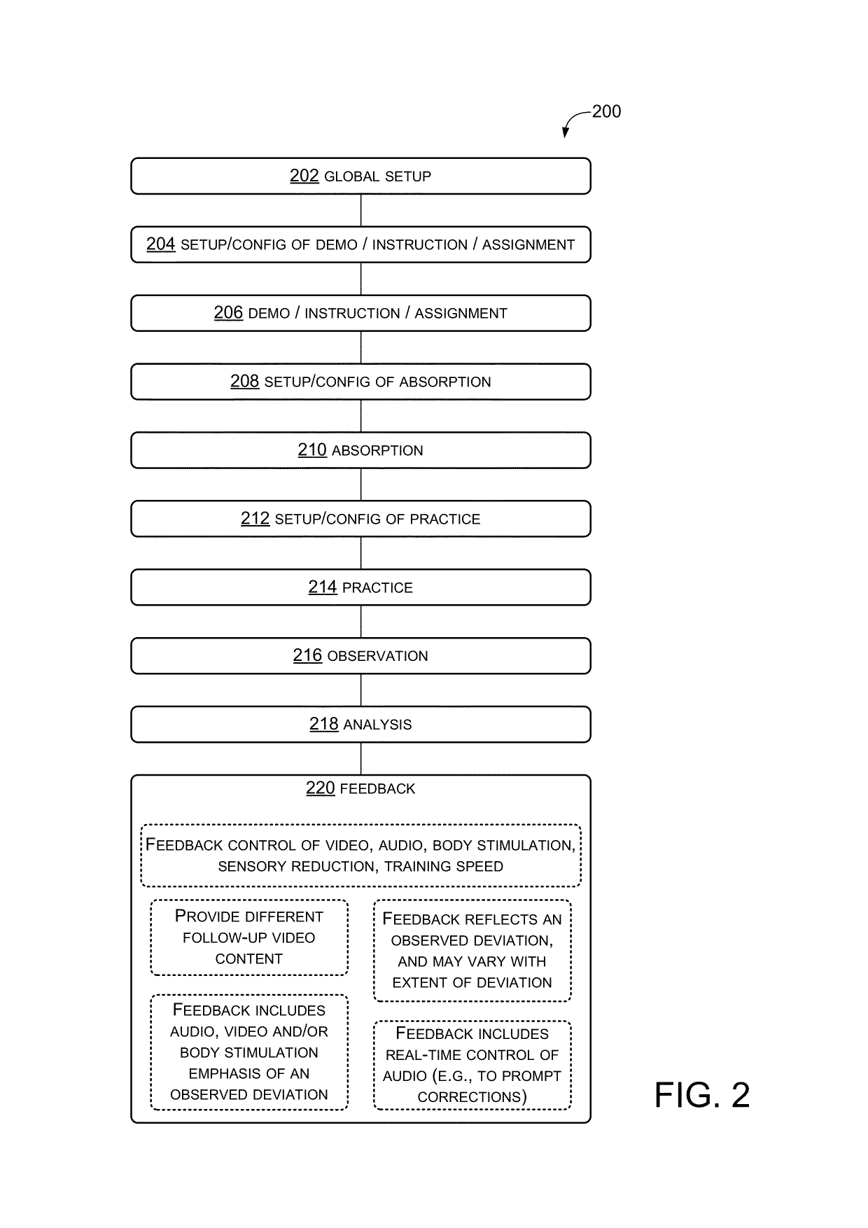

FIGS. 1 and 2 show a system 100 and method 200 for training individuals to perform bodily movements. Such individuals may include athletes, physical therapy or other medical patients, participants in yoga classes, individuals wanting to improve posture, workplace training, flexibility or range of motion, to name a few non-limiting examples. These individuals may work with coaches, doctors, physical or occupational therapists, or others that may help the individual in their motion learning and practice. The two individuals in this training endeavor will be referred to in general as the “teacher” and “student,” unless the context lends itself to a more specific identification, such as “coach” and “athlete.”

FIG. 1 shows a teacher T and student S that may interact in various ways with the student. System 100 may be implemented in whole or in part as a computing device having software and hardware components such as those found in desktop, laptops, tablet computers, smartphones, etc. The system may also include motion sensors and other hardware that is more specific to the functionality that will be described herein. In some cases, it will be appreciated that the computing system can be implemented with such sophistication that it may be properly considered the “teacher” in some cases. And in this regard, it will be understood that many of the examples herein do not at all require the participation of a human teacher.

With respect to the example methods that will be described, the methods will be described as including various steps, some of which will be shown in flowchart diagrams. These flowcharts may at first appear to imply that steps are performed serially in a particular order. And in fact, it will often make sense that some steps are performed in a particular sequence. That said, it should be understood that different sequences may be employed, some steps may be performed concurrently with other steps, some steps may be omitted altogether, and still further, additional steps may be employed without departing from the spirit of the invention. Also, the example methods may be carried out using the hardware and software configurations herein, or using hardware and software different from what is shown and described.

Continuing with the topic of steps, the present systems and methods may be thought of in terms of sessions and cycles. For example, training a student to perform a particular motion may include a first session that may variously be referred to as a communicating session, or a demonstration or instruction session. This often includes communicating a model example of a bodily motion to the student. In some cases, this will include displaying a model video example of the motion. This first stage can also be thought of as an “assignment” session in the sense that its purpose is often to assign an exercise or other motion to be practiced.

After the demonstration/assignment stage, the training may include an absorption session. In this session, the objective normally is to create an environment or conditions that increase the ability of the student to focus upon and neurologically absorb the information they have received during the prior session (e.g., during video display of a professional athlete optimally performing an athletic motion). Absorption may include playing music or other audio, suppressing sensory inputs, facilitating states of relaxation, etc.

Finally, a practice session occurs, in which the student practices the motions. In some cases, it may be desirable to practice at different speeds, in order to facilitate and enhance the learning process.

Occasionally, a grouping or sequence of the above sessions may be referred to as a training cycle, and a cycle can involve more than a simple three-session sequence such as demonstrating, then absorbing and then practicing. For example, a cycle might include a first video display session followed by an absorption session, followed by another display session, and then another absorption session, and then three practice sessions at different speeds. Any sequencing or grouping of sessions can be thought of as a cycle. In some cases, a cycle is characterized by a particular focus. For example, in a first training cycle a golfer may be focusing on their overall golf swing. A second training cycle for that athlete could focus more specifically on the golfer's left arm. In some cases, a change in focus is made in response to electronic observation of the student's performance, using motion capture or other sensing technology as will be described in more detail below.

Referring back to and continuing with FIGS. 1 and 2, system 100 typically will include a user interface 102, including a teacher interface 102a and a student interface 102b. These interfaces allow the teacher and student to establish goals, specify particular motions to practice, and provide a variety of other inputs used to control and otherwise affect the training sessions and cycles. And the student and teacher may of course interact with each other in order to best take advantage of the features of the system and craft an effective course of training In addition to front-end manual inputs received through user interface 102, a wide variety of programmatic inputs may influence and control the training, meaning that such influence and control occurs without the need for human intervention. In many cases, these programmatic inputs are provided in very fast feedback loops, so as to best tune the training to produce the best results. For example, if a golfer is more or less instantly informed of an error in some aspect of their golf swing, that will often provide the best opportunity to quickly and effectively make the necessary correction. Physical therapy patients receiving instant guidance will have better outcomes, and at lower cost given the leveraging of hardware and software technologies that can provide guidance with less time inputs from the therapist.

System 100 may further include a storage subsystem 104 for storing data and software instructions to carry out the features of the system and method. Among other things, the stored content may include audio and video content that is presented to the student to help them learn the bodily motions of interest. For example, a video showing a professional swimmer optimally performing a particular swim stroke may be stored in storage subsystem 104, for presentation to the student in one or more display sessions. As will be described below, the student's practice of the motion may be recorded by video or other means, and this recorded data may also be stored in storage subsystem 104. Audio content may also be stored, as will be described in further detail below. Beyond this, virtually any other type of data may be stored in storage subsystem 104. For example, the storage subsystem can store medical histories; information about injuries; information about past performances; information about settings used in particular training cycles and the results obtained with those settings during physical practice; libraries of video and audio content; any of the inputs received via user interface 102; etc. Any information relevant to motion training may be stored in storage subsystem 104 and used in various ways during the training And as indicated above, the storage subsystem contains executable instructions (e.g., instructions 105) to carry out the steps of the methods described herein.

System 100 may also include a content creator/generator module 106; an output subsystem 108 including a display device and an audio output device; absorption setup module 110; practice session configuration module 112; an electronic observation subsystem 113 including a sensor 114 spaced from the student and/or wearable sensors 116 affixed to the student; and a processor 118. In keeping with the idea of assigning exercises to a student, module 106 may also be referred to as an “assigning” or “assignment” module or subsystem. In general, module 106 generates and manages content which is output to the student by output subsystem 108; absorption setup module 110 configures and manages provision of sensory-reduced sessions, described elsewhere herein, in which audio/video stimulus perceivable by the student is suppressed; practice configuration module 112 configures and manages practice sessions in which the student practices bodily motions; electronic observation subsystem 113 observes and records information, e.g., about student's practice sessions. The processor can carry out any number of functions, including the execution of instructions 105 for carrying out the features, functions and method steps described herein.

As shown in FIG. 1, output subsystem 108 may also include a head-mounted display 120, including a display device 122 (e.g., small screens positioned in front of the student's eyes) and an audio output device in the form of earphones 124. In addition to providing audio and video output, the display screens and earphones may be used to suppress one or both of audio and visual stimulus perceivable by the student (e.g., by blackout out the screens, turning down volume, white noise, noise cancelling, etc.), so as to provide a sensory-reduced session.

Method 200 will now be described with occasional reference to the components of system 100, though it will again be appreciated that other hardware and software components may be employed other than those of the example of FIG. 1. Briefly, and in general, method includes a global setup step 202 entailing a holistic, high-level design and configuration of the training; a setup step 204 for configuring the period in which audio/video instruction is provided to the student, e.g., using content and assignment module 106; the providing of motion instruction to the student (206), for example with output subsystem 108 to deliver audio/video; setup and conducting of an absorption period (208 and 210), for example using module 110 and head-mounted display or other sensory-reducing means to provide a sensory-reduced session; setup and carrying out of the actual practice of the motion (212 and 214), e.g., using practice configuration module 112 and providing audio/video output with output subsystem 108; and respectively at 216, 218 and 220: observation of the student's practice, analysis of the practice and other aspects of the training, and the use of feedback to influence and control various aspects of the training

As indicated at 220, and which will be explained in detail below, feedback features may include, in response to and based on electronic observation of student practice: (1) controlling, in any type of session, the use of audio, video, body stimulation, sensory reduction and/or training speed; (2) providing follow-up video content for viewing by the student, which differs in at least one aspect from previously displayed content; (3) reflecting the existence, extent and nature of an observed deviation in the student's practice from a desired performance; (4) emphasizing or providing indication of an observed deviation from a desired performance, where audio, video and/or body stimulation provides the emphasis; and/or (5) real-time control of audio presented to the student.

Turning to global setup step 202, in this step the overall features of a training cycle are established. Use of the term “cycle” again alludes to the fact that the steps of method include stages performed in various orders, and/or that are iterative and likely be performed repeatedly during the course of training a student. Global setup may include receiving explicit inputs from the teacher and/or student, for example through a user interface such as that shown at 102 (FIG. 1). In keeping with the idea of a high-level global setup, this step may be an appropriate time to set longitudinal goals that are somewhat removed from the specifics of a particular bodily motion. A runner, for example, may want to achieve a top-10 placing in their age group, reduce a personal best time by some amount, etc.

Again, a wide variety of inputs may be applied at the front end—overall goals of a training program; medical history; information about past performances or past training regimens; and information about specific exercises that are to be practiced or performed. Athletes that perform timed events might include personal best times that have been achieved in the past; golfers might specify the distance they can achieve using various golf clubs; athletes in general might include information about equipment they use. Selections might be made about particular video content or audio content to be presented to the student to help them consciously and subconsciously develop a mental picture of how their body needs to move in order to achieve the desired progress. If an athlete would like to emulate the style of a particular professional, they could elect that all example video content be of that professional. For example, a swim student might elect to view performances from a particular Olympic swimmer; a golfer might want to see a particular professional golfer; etc. These are but a very few of the nearly limitless potential inputs.

In the context of inputs that influence the training, it should be again noted that a wide variety of programmatically determined inputs may be employed, in many cases as feedback received from other stages. For example, motion capture analysis may reveal that an athlete's practice needs improvement in one particular area. This information can then be fed back and used to modify video content presented to the athlete in a subsequent video display. In particular, the new video content could emphasize the particular aspect of the motion needing improvement. Another example of feedback is comparison of results obtained during multiple practice stages. The practice session in which the largest improvement was achieved could be analyzed, for example, to determine what occurred in other steps leading up to the practice (e.g., how the absorption was conducted). Such feedback could be used to make optimal selections for how the video presentation and absorption are to be conducted. In still another example, feedback can be used to control the playing of audio content. Audio content is sometimes preferably synced in a particular way to the student's practice. For example, it might be useful to match the tempo of a song to the frequency of some repeated motion (e.g., a cyclist's pedal stroke). Motion capture could be used to assess the cyclist's actual cadence in real time, which in turn could be used to ensure that audio being played to the athlete was synchronized with the pedal strokes. In still another example, stimulation of an athlete's body might be tuned from a baseline regime based on a motion capture determination that the athlete was having difficulty with some aspect of a motion. Electro-stimulation of a golfer's arm might be useful for example, as a reminder to move the arm in a particular way. And such a need could be determined through a motion capture analysis that this aspect of the golfer's motion was the issue that most needed to be addressed.

Yet another example of feedback could be a determination that an athlete experienced the biggest improvement when listening to a particular song or other audio content. In such a case, that song could be automatically selected by software so that it would be played to the student at an appropriate time in a subsequent training cycle or stage. Perhaps a training session requires a patient to perform a series of exercises, and video data or another observation method reveals that one or two exercises in particular are not being performed to a satisfactory level, or that those exercises needed to be focused on for some other reason. Then the initial configuration at 202 could include making sure that those exercises were emphasized in an upcoming cycle. Feedback could also be used for motivational purposes, for example to positively reinforce that progress is being made, which in turn might cause the student to be more diligent or follow through with a course of training Also, instead of negative feedback, electronic observation might reveal that mastery has been achieved for a particular exercise, in which case the student would then be moved on to other exercises and new audio and video content geared toward that new motion.

It will be further understood that the feedback mechanisms herein are capable of operating very rapidly, in order to provide feedback at a point in time when it can be used to the greatest advantage. For example, in a conventional physical therapy setting, a patient visits the therapist's office and is guided through various exercises. The patient then leaves with instructions to perform various exercises at home. The patient can certainly self-observe how their home practice progresses, however that monitoring will be conducted without the benefit of 3rd party objectivity, and even when a third party receives information about the practice (e.g., at a subsequent office visit), the feedback will be delayed in time by days or even weeks from when the actual home practice occurred. Also, it is quite possible that the patient will not even recognize difficulties in the practice. By contrast, the present method can include automated video and motion sensing recording and immediate real-time analysis of the recorded data, which in turn can be leveraged more or less immediately to guide the practice. Use of feedback can occur within seconds of observing the student's practice. And best practices can be uniformly adhered to, in the sense that a fully researched model motion can be used as the yardstick which controls performance measurement and response to the measured performance.

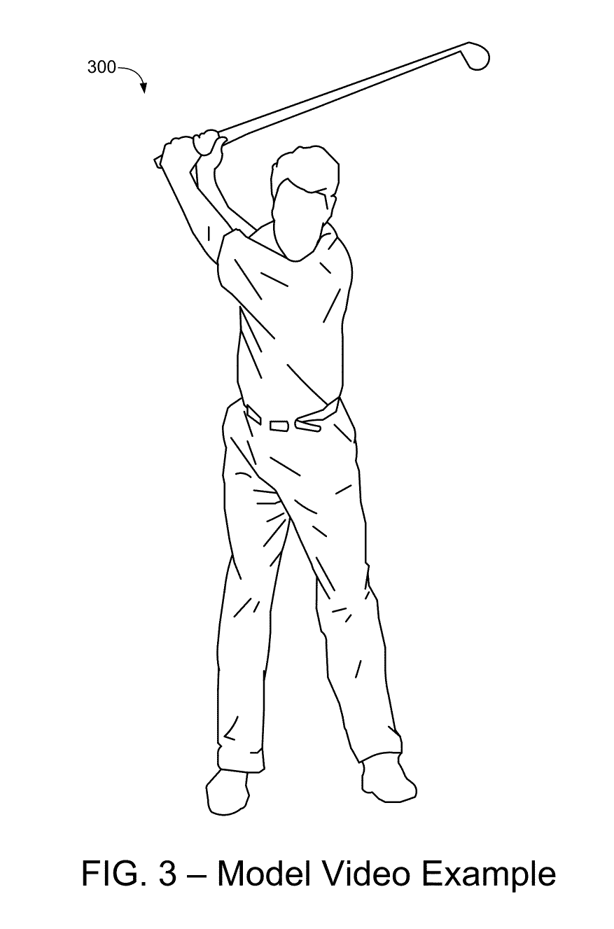

Continuing with FIG. 2, method 200 may further include, as shown at 204, a content creation/generation step, which may be performed, for example, by module 106 of FIG. 1. In most cases, video content will be desirable for providing up-front guidance to the student as to the aspects of the ideal motion. As previously described, the video content typically will include model video examples showing optimal performances of the bodily motions to be trained. FIG. 3, for example shows a frame from a model video example 300 of a golf swing. Such an example may be displayed using the output subsystem of FIG. 1 (e.g., on a head-mounted display such as shown in FIG. 1). Generally any type of example may be provided, for any movement or type of movement. A wide variety of other athletic motions may be demonstrated by video (e.g., using renowned professional athletes); physical therapy or other therapeutic movements may be demonstrated; correct postures for sitting, lifting heavy objects, etc. may be shown; video of yoga poses can be displayed. The possibilities are limitless. And as previously discussed, virtually any type of input, whether manual or programmatic, whether feed-forward or part of a feedback mechanism, and from any other stage of the practice or component of system 100 (when such hardware/software is employed), can be used to select and generate audio and video content to be presented to the student.

In addition to providing a whole unmodified example of a motion, modified or supplemental content may be provided or generated. For example, a video of a swimmer may include multiple versions in which different aspects of the swimming stroke are emphasized, for example the arms, legs, or the rotation of the torso occurring as the swimmer takes breaths. Feedback may be used to select the appropriate versions. For example, assume that a model video example is displayed in a first display session. Feedback may then entail providing follow-up video in a subsequent display session, which differs in at least one aspect from the first-displayed example. For example, electronic observation of a swimmer might reveal that they were not kicking hard enough, and the follow-up content could emphasize the legs shown in a model video example.

When emphasis or de-emphasis is employed in video, the non-emphasized part of the body may be rendered in black-and-white, with the emphasized portion in color. As another example, the non-emphasized parts of the body may be dimmed. Any method may be used to emphasize or de-emphasize as necessary. Moreover, an entirely different video may be employed as follow-up content, for example in the case where feedback or other inputs dictate that the student move on to another movement or exercise. And it should be again emphasized that feedback inputs can be positive. New video content might be selected after a student has mastered an exercise, the new video content being, for example, a more difficult exercise that the student has demonstrated they are ready for.

Video content, whether in an initial display session or a subsequent display, can have various other characteristics. Various objects in the may be occluded, for example. In follow-up feedback video, occlusion may be used to emphasize or de-emphasize certain elements, for example in response to observed deviations from a desired performance. Luminescence and color variations may be employed for various purposes, including to highlight observed problems with the practice. Follow-up video content may be edited to only show particular aspects that were shown in a prior display, again to emphasize deviations or for other purposes.

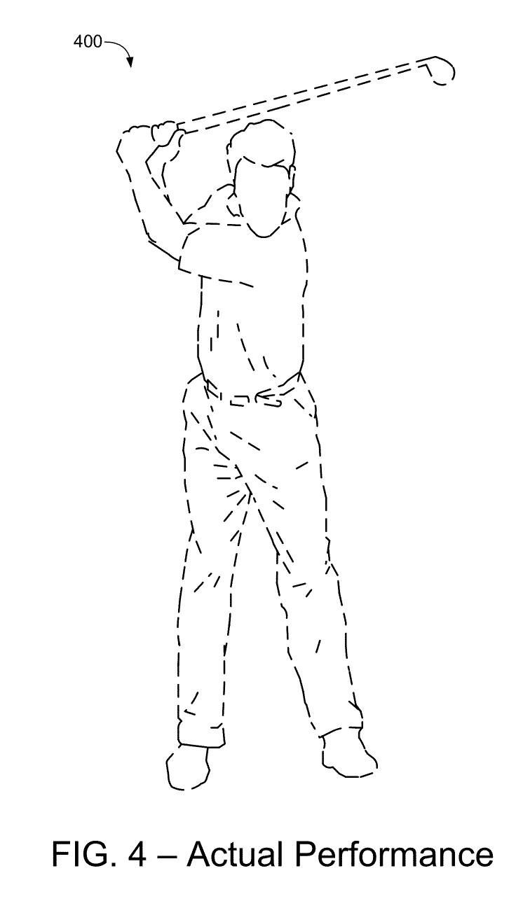

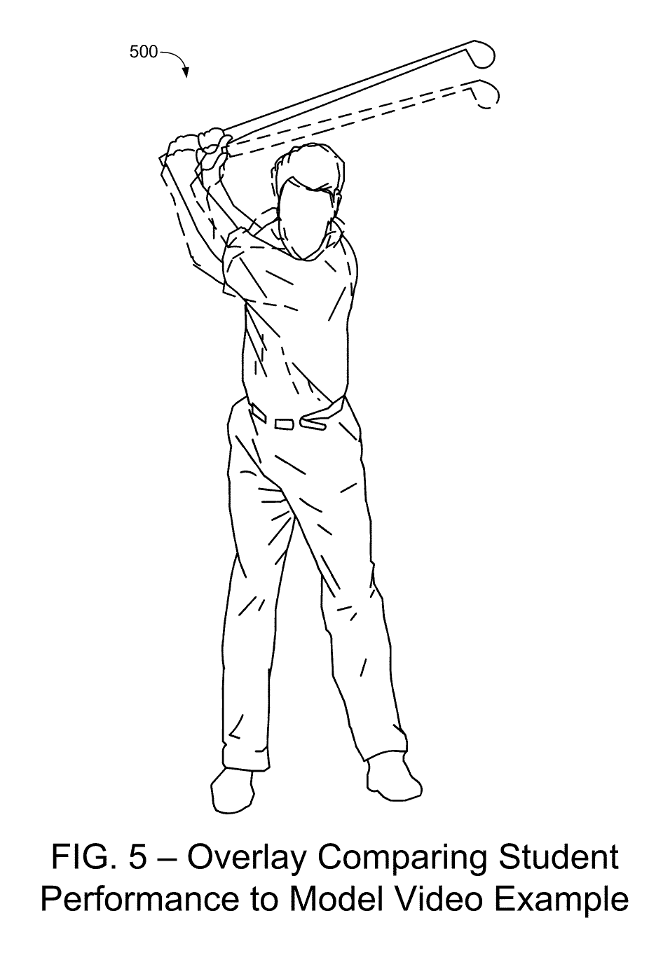

FIGS. 4, 5 and 6 provide illustration of feedback and how step 204 can be influenced by that feedback. Let's first suppose that a golfing student was first shown model video example 302 in a first viewing session (i.e., iteration of step 206). Then, during practice 214, motion capture video is employed (step 216) to observe the practice. The feedback provided to the student may occur in a subsequent iteration of step 206. In this second session, the student may be shown stills or video of their actual performance, as shown at 400 in FIG. 4. FIG. 5 provides another example of the feedback-generated content that can be shown to the golfer, in the form of an overlay of their performance on to the model performance—overlay video shown at 500 in FIG. 5. A note on FIGS. 3-6: while the clothing, body shape, etc. appears the same for the figure in bold lines as the one in dashed lines, this replication is simply for purposes of simplicity, particularly with respect to the overlay. In actuality, the actual student will appear in the stills and video, and they will of course look very different than the professional athlete appearing in the model video example.

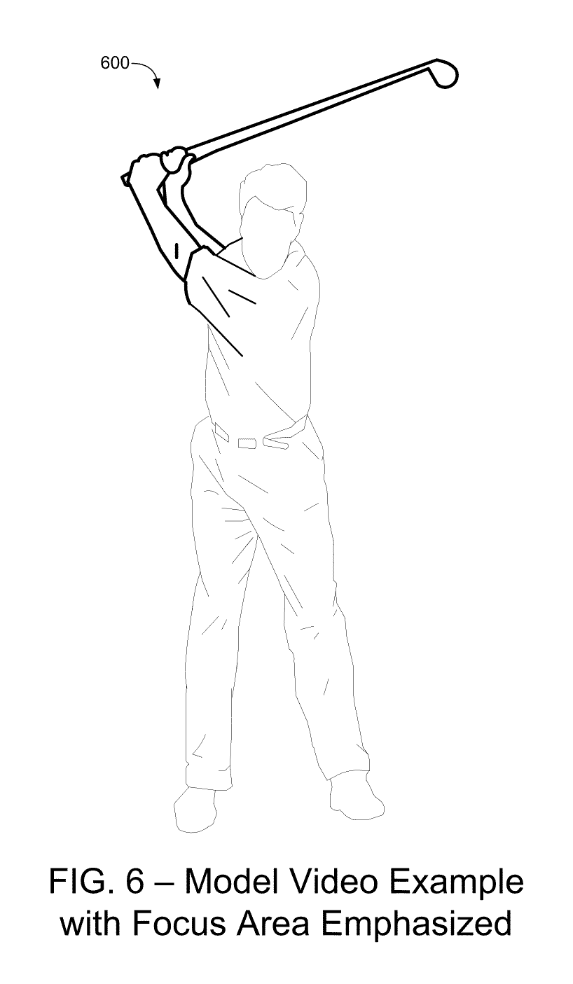

After the student has seen their actual performance, a modified version of the model example can be shown, as follow-up video content in a subsequent display session, in which a particular aspect of the golf swing is emphasized. FIG. 6 shows an example of such follow-up content. Here the video example 600 is similar to example 300 of FIG. 3, except that the arms are emphasized, because it was determined in the observation 216 and analysis 218 steps that the golfer's main difficulty was their arm positioning. Electronic observation thus has been efficiently leveraged to tune the training to emphasize the specific area in which the student needs to improve.

Content that is presented to the student at step 206 (and other steps) can also include audio. Any type of audio may be employed, although the inventors have determined that some types of audio provide specific and clear advantages in certain settings. The audio may include a student-selected song. A song or other audio clip could be selected based on it having a particular tempo, which can be advantageous in training repetitive motions that the student should perform at a particular frequency. In this regard, a 400-meter runner might select a high-energy motivational song having a tempo that matches their optimal stride for the 400-meter distance. As another example, cyclists often focus closely on pedaling cadence, such that selection of music with a specific tempo can be quite helpful. Another type of audio content is binaural beats.

At step 206, method 200 includes the actual presentation of content to the student. As indicated above, this step may be variously referred to as “instructing,” “demonstrating,” “presentation,” or “assigning,” which reflects that distinctions are appropriate in some cases based on the precise purpose to be achieved. For example, in many cases, the term “demonstration” is clearly applicable; many examples include using a video to demonstrate the motion to be performed. “Assigning” can refer to step 206 being carried out to assign particular motions or aspects of motions to practice. A teacher in the form of a physical therapist can “assign” specific exercises for a patient, and can also “instruct” the patient so as to enhance and improve the practice experience. And the word “presentation” will also be appropriate, for example the playing of audio to the student may be naturally described as a “presenting” activity. However, setting aside these subtleties, the essence of step 206 is that the student is given information about the motion that they are to practice. The providing of information may include displaying video and/or playing audio, as has already been discussed. In other examples, body stimulation may be employed during step 206. In the example of FIG. 1, content is provided to the student via the output subsystem, which may include one or more display devices and audio output devices.

If audio is employed at step 206, it may be useful to re-play that same audio (or with certain modifications) during absorption 210 and practice 214 sessions. Although the audio may be played in various ways, including with modifications, additions and/or deletions, it will often be helpful to play it in a way substantially similar to when it was played during step 206. Importantly to some scenarios, the audio will be synchronized to link aspects of the motion shown at 206 (when video is employed) with the student's attempts to perform those aspects—e.g., the same moment in the audio occurring as the model swimmer places their right arm in the water would be played as the student is placing their right arm into the water during the practice. In some cases, this may be referred to as “maintaining an audio-motion synchronization.” In other words, each moment of the audio has a corresponding associated moment in the motion, whether the motion is displayed in a video or is being practiced by the student. When such synchronization is employed between the demonstration and practice, the synchronized audio during practice can aid in properly activating the neuromuscular systems needed to properly perform the motion. Common, synchronized audio can provide a powerful “neurological anchor” that beneficially links the demonstration, absorption and practicing of the motion.

Typically it will be desirable that the audio content and its delivery be configured to induce the student to cognitively absorb the model video example, particularly during sensory-reduced sessions. This may include selection of a tempo, for example so that audio events are synchronized with particular motion events. This may be particularly useful for repetitive motions occurring periodically. In addition, patterned and directed audio may be dynamically time warped to replicate a programmed motor pathway that meets predetermined speeds or affords adjustable speeds to induce cognitive learning for skill acquisition to become task oriented.

Regardless of whether played during demonstration, absorption or practice, the control of audio may be based on a variety of inputs. Feedback inputs based on electronic observation of practice can be particularly useful. The feedback in general may include controlling playing of audio during one or more of: (i) a subsequent display session; (ii) a subsequent sensory-reduced session; and (iii) the first practice session; and (iv) a subsequent practice session.

During subsequent displays of video content, audio may be controlled to provide or emphasize an area that needs improvement, which may have been detected by electronic observation. Such areas can also be highlighted with video content, using methods of emphasis or de-emphasis as described above. During sensory-reduced sessions, audio control based on feedback can include: speed control (e.g., in response to determining using motion capture that display/absorption/practice should be adjusted, for example made slower, to facilitate learning); and volume control for various purposes, including emphasis of particular aspects of the motion being practiced. Another example of control during a sensory-reduced session is an observation that a particularly-configured sensory-reduced session was followed by a particularly good practice session. In such a case, control could be performed to repeat the same configuration in subsequent sensory-reduced sessions.

During the practice itself, motion capture can ensure audio is played at an appropriate tempo and properly synchronized to the motions the student is attempting to perform. When the student deviates from a desired performance, immediate audio feedback can be provided, for example as a volume change, distortion, beat tones or other warning-type sounds, removal or addition of other audio components, etc. The electronic observation system may also observe the student practicing at other than a desired speed, in which case audio playback can be controlled to prompt or induce the student to speed up or slow down the practice. And again, the feedback generally will be performed based on observation 216, analysis 218 (e.g., is the deviation large enough to be determined an insufficiency) and feedback 220.

As indicated above, method 200 also includes a period in which the student focuses on the video or other information provided at 206, in order to consciously and subconsciously absorb and internalize the motion being learned. At step 208, the absorption environment is configured to provide such a sensory-reduced session, which can include selection of audio and or video content to be played, including in modified forms. Selections may also be made at this step regarding suppressing the ability of the student to take in sensory inputs from their environment, so as to produce a sensory-reduced session. A device such as head-mounted display 120 may be used to black out a display, provide “white noise” audio or video, noise cancelling/blocking, etc. Such a sensory suppression can enhance absorption in some cases. Usually, one goal of the absorption period is to design it so as to induce a state of relaxation, so as to place the student in an emotional and mental state in which they are receptive so as to optimally absorb the content. Suppressing audio and/or visual stimulus can facilitate relaxation, eliminate distractions, and otherwise enhance focus, visualization and internalization of the information. And as before, the particular settings may be influenced or determined by virtually any type of input, programmatic or manual, feed forward or feedback, and from any step or software/hardware component. In one example, an analysis may be performed as to what absorption settings were followed by the best performances of the student, so that the most helpful settings can be replicated in upcoming absorption (e.g., via steps 216, 218 and 220). The absorption period itself occurs as shown at 210.

Audio content may have other characteristics to enhance training Audio content may be mapped to velocities and positions for various significant mechanical points of interest in a bodily motion. Audio may be structured to have specific notes, pitch, frequencies, binaural beats, etc., regardless of whether played during video display, sensory suppression or practice. During sensory reduction, the notes, pitch, binaural beats, etc. are structured to maximize attentiveness and relaxation. The audio content employed may be selected based on empirical determinations of its ability to achieve cognitive and physical benefits. Also, as discussed elsewhere herein, student performance over multiple cycles and sessions can be evaluated in order to identify optimal characteristics and uses of audio content.

Steps 212 and 214 pertain to the actual practice of the movement by the student. At 212, the upcoming practice session is “configured,” in the sense that selections are made with respect to the particular movement or aspects of movement to be practiced; the environment in which the movement will be practiced; whether and what type of audio and video will be provided to the student during the practice; whether and how the practice will be observed and monitored; whether and how the student will be provided with real-time feedback as the practice occurs; the speed at which the motions will be practiced; whether haptic or other sensory stimuli will be provided, etc. As with other setup steps, these selections may be made with any type of inputs, as discussed above and including feedback based on observation 216 and analysis 218. The actual practice is carried out at step 214.

Practice may be carried out at various speeds. A given speed may be determined in advanced and enforced via various methods. Enforcement of speed may include controlling an audio track to play at a particular tempo, or controlling the frequency of a repeated tone or sequence of tones. Speed control can be used to prompt changes in the student's speed. For example, if the student is moving slower than desired, the tempo of accompanying music can be increased slightly, so as to induce the student to “chase” the audio and converge to synchronicity. On the other hand, audio can be slightly slowed to signal a need for decrease and induce such decrease. Enforcing practice speeds can be very helpful—one can well imagine that an optimum path to mastery would be to first start at a slower pace. And speed control could rein in the overeager student who wants to proceed at a fast tempo before they have a sufficient grasp of the basics of the movement.

On the other hand, it may be useful to let the student proceed during actual practice at a speed that is comfortable for them. In this case, which involves a non-predetermined speed that may fluctuate, it will be useful to implement certain controls based on a real-time observation of the practice. Again, this would involve the previously-referenced steps 216, 218 and 220, with motion capture or another mechanism for recognizing the speed of the practice. Knowing the speed may be important if it is desired to play audio or otherwise provide the student with stimulation or other information at specific times, for example wanting an audio segment to occur while the student is practicing a particular aspect of the motion. Whether speed is enforced on a predetermined basis or allowed to occur organically, any range of speed may be employed. Indeed, speed may range from very slow to a rate beyond anything that would be desirable during actual practice of the activity (e.g., faster than a particular dance step would ever actually be performed in a normal dance setting).

As previously indicated, the efficacy of the systems and methods described herein can be greatly enhanced via observation and monitoring of the student's performance. Indeed, example method 200 includes, at 216, electronically observing the student's practice. Electronic observation may be performed, for example with electronic observation system 113, using optical technologies such as time of flight, structured light, marker tracking with active or passive markers, and non-optical methods, such as with accelerometers, gyroscopes, magnetic tracking, etc. Other data may also be obtained, such as heart rate, respiration rate, work rate (e.g., strokes/strides/revolutions per minute), time needed to perform an exercise or cover a specified distance, etc.). At 218, analysis may be performed, which in turn can produce feedback that can send inputs to or control other stages, as shown at 220. The possibilities for control based upon observation and analysis are limitless.

As mentioned above, observation at step 216 is often conducted to determine that the student's practice of the motion has deviated from some desired performance (e.g., arm at the wrong angle, incorrect posture, timing of a motion being early/late, etc.). Feedback can reflect this deviation, and in some cases will vary with the extent of the deviation. The deviation can affect the setup, configuration and output provided at steps 202, 204 and 206. As an initial matter, the student may be shown video or other information recorded about their practice (see FIG. 4, a video of student's actual performance; and FIG. 5, a video overlaying the actual performance on to of the model example to facilitate recognition of problem areas). Continuing with the case of recognized deviations, analysis might reveal that the deviation indicates that the current bodily motion is too difficult for the student, which in turn can lead at 202 to the selection of a more appropriate bodily motion to practice. On the other hand, analysis of the deviation might result in a configuring, at step 202, so that the subsequent steps continue with the same motion, but with an emphasis geared toward correcting the specific deviation. Analysis might reveal that the student's performance has characteristics that carry an increased risk of injury, and this information may be used in steps 202 and 204 to modify subsequent stages to address the risk. For example, if a weightlifter was using a risky hand position, modified video content emphasizing correct hand placement could be selected at 204, for presentation to the athlete in an upcoming demonstration stage 206 (see FIG. 6).

Another example: an observed deviation might affect or control the audio played to the student during stage 206. Suppose that multiple iterations of step 206 had occurred, and that the subsequent practice at iterations of step 214 had produced varying results. The analysis could identify the audio that was played at 206 that lead to the best performance (e.g., with the least deviation). This audio would then be selected for subsequent iterations of the 206 step. In another example, audio can be controlled to provide cues that occur at specific times as the student practices. If the observed deviation occurred for only a few moments during the student's practice, the audio in 206 could be varied at the corresponding moment when a model video example is being played. Specifically, if a golfer's deviation occurred at follow through, the feedback control of audio can include, while the golfer is subsequently watching a video model example, changing the audio at the moment of follow through, to emphasize that aspect of the motion.

In some cases, it will also be desirable to play audio content during the absorption stage 210. Control of this audio based on an observed deviation can also be performed. Referring to the above example where audio is varied at the moment of deviation, a similar feedback-based timing may be used. Another example of audio control during demonstration and absorption would be a determination that a different speed should be used. For example, if the student's performance at slow-speed practice has improved significantly, then the video and associated audio played in steps 206 and 210 could be played faster.

Deviation-based feedback control can also affect the actual practice. As just mentioned, electronic observation of a deviation can be used to vary practice speed or the speed used on other stages. For example, if a lot of deviation were observed, then the feedback may result in practice stage 214 being conducted at a slower speed. Real-time audio feedback can be used as well. For example, at the moment of deviation, an audio variation can be introduced to alert the student to make a correction. Audio variation can be introduction of new content, change in volume, introduction of distortion, to name a few non-limiting examples. Electronic observation may indicate practice occurring at other than a desired speed, and audio can be controlled to prompt the student to increase or decrease the speed of the practice.

As mentioned above, varying the speed of practice can enhance training In addition, it will often be useful to control speed of audio and video during display sessions (e.g., at step 206 in FIG. 2) and sensory-reduced sessions. In many cases it will be helpful to begin at a relatively slow speed, with video demonstration of bodily motion and associated audio content beginning at a relatively slow speed. Slow speeds allow the student to focus more closely on a motion or particular aspects of the motion. In particular, slowing down video to below-actual speeds can greatly enhance learning. Typically, the same audio content would then be played at the same speed in a sensory-reduced session following the display. The use of the same audio can help to induce greater cognitive absorption of the model video example shown to the student. Repeated sounds during the absorption period can focus the student on the aspects of the motion that coincide with those sounds. And in some cases, this benefit will be greater if the same speed is used. That said, a different speed may be used in the display and sensory-reduced sessions.

Training typically includes multiple iterations of the different sessions (display, absorption, practice), and speed will often be changed in subsequent sessions. For example, video and audio speed will often be increased in subsequent display and absorption sessions. These subsequent sessions can occur during a given workout, or they may occur days or weeks later. Generally, a speed increase is used as the student improves. It will also be understood that video and audio speeds may be decreased, for example if the student's performance deteriorates.

Audio/video speed control will often be implemented as feedback based on electronic observation of performance. Improved performances can lead to increased speed in subsequent display and absorption sessions. Similarly, where a student's performance shows some difficulty or deviation from a desired performance, subsequent sessions can be slowed down. These are but examples, there may be other reasons to change speed based on performance.

Returning to control of video, in general, and to summarize, the following video control may be provided as followup video content in response to and based on electronic observation of the practice: (1) speed variations; (2) visual emphasis of certain aspects; (3) occlusion; (4) controlling luminescence; (5) selection of different video content; (6) editing prior video content to retain and display only a portion of the prior content; (7) color modifications; etc. One, some or all of these controls may be used more specifically in response to observed deviations from a desired performance. These may also be based on improvements or other electronic observations of the practice. Again, for example, analysis might reveal a student has achieved mastery in a particular exercise, in which case the follow-up video could provide praise or some other indication of success, and/or video of a new motion or motion aspect to be trained. Performance may indicate a speed change would be helpful, even though there is not a specific problem area.

Regarding audio, it has been discussed that audio may be configured to induce enhanced cognitive absorption of the motion being trained. In addition, and in summary, audio may be controlled based on electronic observation: (1) to adjust speed, for example based on observing that subsequent sessions should be performed at a different speed, or to account for observed difficulty, mastery or improvement; (2) to adjust speed to synchronize audio to actual observed performance; and (3) to control volume, distortion, adding/removing components, etc., in response to observed difficulty, mastery, improvement, etc. These are non-limiting examples—a variety of other audio controls may be employed in different settings.

Still further, with respect to audio and/or video, electronic observation can be used to compare performances occurring in different practice settings. The systems and methods herein may be tuned by analyzing what audio and video settings, changes, etc. were followed by the best performances. These settings can then be replicated in subsequent training activities.

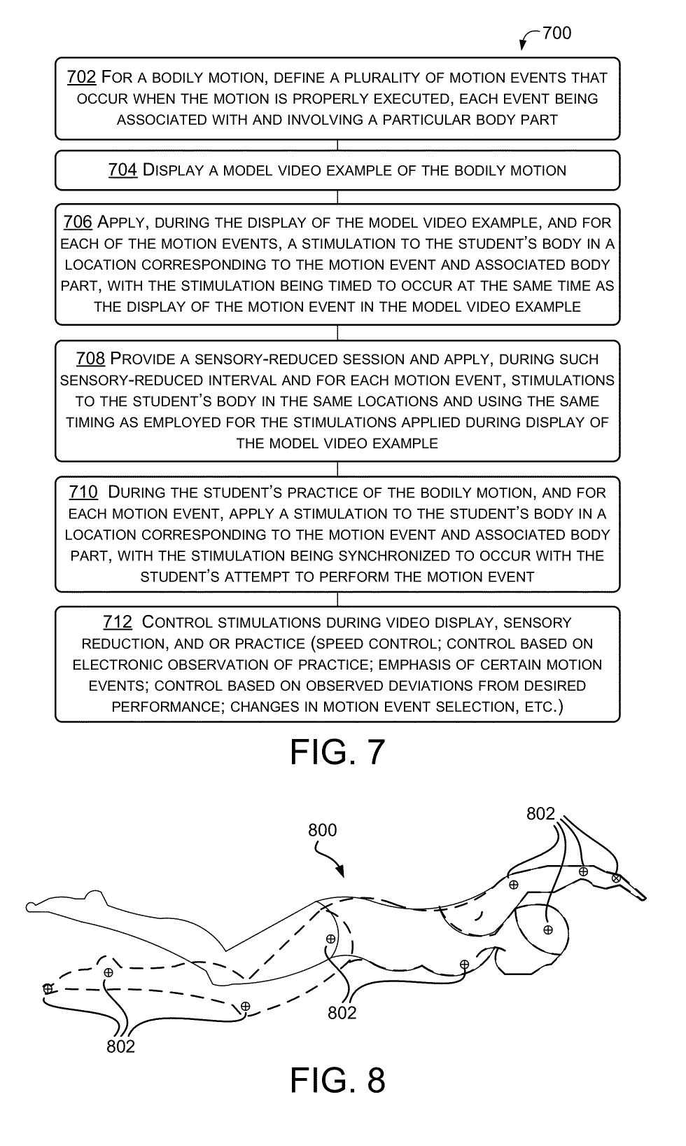

Referring now to FIGS. 7 and 8, FIG. 7 shows an example method 700 for training bodily motions using body stimulations, and FIG. 8 shows aspects of the method in reference to depicted swimmer 800. Incidentally, FIG. 8 provides another example of video content that can show an actual performance deviating from a desired performance—here one of the swimmer's legs (dashed) is lower in the water than in the model example (in solid lines).

Continuing the topic of stimulations, is In some implementations, stimulating the student's bodies in selected locations can enhance motion training Stimulation may be performed using various methods and technologies. In some examples, electrical stimulation is performed with electrodes. In other examples, pressure, vibration, temperature, touch or other haptic signals and stimulation are used. As seen in FIG. 8, a number of stimulators 802 are affixed to the body of swimmer 800. These stimulators may be electrodes adapted to stimulate muscular activity, haptic devices that provide pressure, compression, vibration, heat, cold, etc. In some implementations, these devices may be incorporated into a garment worn by the student, such as a swimsuit. The stimulators typically are driven by signals (e.g., wireless signals) that are output as a result of executing software instructions, for example execution of instructions 105 with processor 118.

Referring back to the previous discussion of motion capture, the placement of stimulators 802 can be used for marker-based motion capture. Alternatively, those locations can correspond to tracked locations in marker-less motion capture methods. Still further the locations may correspond to motion/position-sensing devices such as accelerometers.

Continuing with body stimulation, regardless of the particular stimulation method, it typically will entail, for a given bodily motion, decomposing the motion into a plurality of motion events that occur when the motion is properly executed. The definition and selection of motion events is shown at 702 in method 700. Each event is associated with and involves a particular body part. For example, the follow-through in a golf swing involves a driving motion (motion event) of the hips (the associated body part). A given motion typically will have several motion events, e.g., bringing the golf club backward from an initial resting position; a middle portion of the backswing; the full retraction of the backswing and the attendant position of the arms; the beginning of the forward swing; the position of the head during the forward swing; the driving of the hips during follow through, etc.

The stimulation method may then include, as a model video example of the motion is played to the student, and for each motion event, stimulating a location on the student's body that corresponds to the motion event and its associated body part. Also, the stimulation is timed to occur at the same time that the motion event is shown in the displayed video example. This is shown at steps 704 and 706.

In addition to applying stimulation during the display of the video, stimulation can also be applied during absorption and/or the actual practice of the motion. When employed during a sensory-reduced session, it will often be useful to employ the same timing of stimulation as was employed during video display of the bodily motion, so as to strengthen the mental/physical link between the two stages and enhance the absorption. Stimulation during a sensory-reduced session is shown at 706.

As shown at 710, stimulations may also be applied during practice of the bodily motion. Typically, stimulations are applied for each motion event and associated body part so that the stimulations are synchronized with the student's attempts to perform the motion events. This synchronization may be performed using electronic observation, as discussed above, in order to determine when the student is attempting to perform the motion events. During practice of the motion, it will often be useful to again use the same timing. That said, the student may intentionally or unintentionally practice at a different rate than that shown in the video example. The different rate could be specified and controlled somehow, or could just naturally result from the way the student practiced at a given instant. In such a case, electronic observation (e.g., via machine vision motion capture) can again be used to control the timing of stimulation during the practice, so that the stimulation occurs at an appropriate location on the student's body at the time that the student is attempting to perform the motion event.

Step 712 shows controlling of the stimulations. This control can include stimulation control during video display sessions, sensory-reduced sessions, and/or practice sessions. The control can include speed control; magnitude of stimulation; control based on electronic observation of practice; control to emphasize certain motion events relative to others; and/or control based on an observed deviation from a desired performance.

Regarding speed control, different stimulation speeds and timings may be employed. This can include an overall uniform speed change across the whole bodily motion. Alternatively, speed may be slowed or increased only for portions of the bodily motion (e.g., for a subset of the motion events). In some cases, training cycles may be arranged to have a pre-defined use of different speeds. For example, a slow speed might be used for initial display, sensory-reduced and/or practice sessions, with speed being varied in subsequent sessions, for example speeding up as practice improves. Selecting a speed may be performed based on electronic observation of practice, for example to emphasize a difficult area (e.g., to reflect an observed deviation on a particular motion event), or based on an observation that the student would benefit somehow from a different speed (e.g., based on mastery at a slow speed).

As just briefly mentioned, electronic observation (e.g., with system 113 of FIG. 1), can be used to control stimulation. This can be used to control any types of session (display, sensory-reduction, practice). In a current practice session, speed can be changed, stimulations can be applied to emphasize certain motion events, stimulations can signal when the student is deviating from a desired performance, etc. In a subsequent display, sensory-reduction or practice session, certain motion events can be emphasized; stimulation speeds can be changed; etc. In particular observed data might be analyzed to conclude that additional video/absorption/practice should be conducted at a different pace, such as to slow practice down in the event of difficulties.

In general, and to summarize with respect to feedback based on observation, feedback-based control can affect any characteristic of stimulation, both in a current practice session and in any subsequent type of session. The control can include (1) controlling stimulation speed, e.g., to increase or decrease speed in subsequent sessions, for all motion events or any subset of those events; (2) magnitude of stimulation; (3) emphasizing certain motion events, including deviations from desired performance; (4) changing the subset of events for which stimulation is performed; and (5) activating additional stimulation sites; etc. These are but examples, any practicable control can be performed in response to electronic observation. And as with audio and video, electronic observation can be used to tune optimal stimulation settings, for example by analyzing what stimulation methods have caused the greatest improvements in performance. In addition, any of the above methods relating to providing and/or controlling video and audio in display, absorption and/or practice sessions may be combined with body stimulation to aid in the training of bodily motions.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A method for training a student to perform a bodily motion, comprising:
displaying a model video example of the bodily motion to the student in a first display session;
during the first display session, playing audio content that is associated with the model video example;
providing a sensory-reduced session after the first display session, in which one or both of audio and visual stimulus perceivable by the student is suppressed; and
playing the audio content during the sensory-reduced session, where the selection and playing of the audio content in the first display session and the sensory-reduced session are configured to induce the student to cognitively absorb the model video example.

2. The method of claim 1, further comprising:
electronically observing the student's practice of the bodily motion in a first practice session with an electronic observation system; and
playing the audio content again during one or both of a subsequent display session and a subsequent sensory-reduced session, but at a different speed than employed during the first display session, such different speed being based upon the electronic observation.

3. The method of claim 1, further comprising:
electronically observing the student's practice of the bodily motion in a first practice session with an electronic observation system; and
in response to and based upon such electronic observation, controlling the playing of the audio content during one or more of: (i) a subsequent display session; (ii) a subsequent sensory-reduced session; (iii) the first practice session; and (iv) a subsequent practice session.

4. The method of claim 3, where the controlling the playing of the audio content includes dynamically controlling playback speed of the audio content in the first practice session, such dynamic controlling being performed in real-time in response to electronic observation of the student's practice, so as to maintain an audio-motion synchronization which is the same as that employed during the display of the model video in the first display session.

5. The method of claim 4, where controlling the playing of the audio content includes, during the first practice session, providing an audio indication when the student's performance deviates from a desired performance, as determined by the electronic observation.

6. The method of claim 4, where the controlling the playing of the audio content includes, during the first practice session, dynamically controlling playback speed of the audio content to induce the student to change the speed with which they are practicing the bodily motion, in response to determining via the electronic observation that the student is practicing at a non-desired speed.

7. The method of claim 3, where controlling the playing of the audio content includes, during a first practice session in which the student practices the bodily motion, providing an audio indication when the student's performance deviates from a desired performance, as determined by the electronic observation.

8. The method of claim 3, where the electronic observation system includes an optical motion capture system.

9. The method of claim 3, where the electronic observation system includes wearable sensors affixed to the student's body.

10. The method of claim 1, further comprising:
electronically observing the student's practice of the bodily motion in a first practice session with an electronic observation system; and
displaying follow-up video content to the student, such follow-up video content being different than the model video example and generated in response to and based on the electronic observation.

11. The method of claim 1, where the displaying of video content and playing of audio content for the student are performed using a head-mounted apparatus which includes an audio output device.

12. A system for training a student to perform a bodily motion, comprising:
an output subsystem including a display device and an audio output device;
a storage subsystem operatively coupled with the output subsystem and containing executable instructions operative to:
cause the display device to display a model video example of the bodily motion to the student in a first display session;
cause the audio output device to play audio content to the student during the first display session;
cause suppression of sensory stimulus perceivable by the student, thereby achieving a sensory-reduced session; and
cause the audio output device to play the audio content to the student during the sensory reduced session, where the selection and playing of the audio content in the first display session and the sensory-reduced session are configured to induce the student to cognitively absorb the model video example.

13. The system of claim 12, further comprising an electronic observation system configured to electronically observe the student's practice of the bodily motion in a first practice session, the executable instructions being further operative to cause the output subsystem to again play the audio content during one or both of a subsequent display session and a subsequent sensory-reduced session, but at a different speed than employed during the first display session, such different speed being based upon the electronic observation.

14. The system of claim 12, further comprising an electronic observation system configured to electronically observe the student's practice of the bodily motion in a first practice session, the executable instructions being further operative to, in response to and based upon such observation, control the playing of the audio content during one or more of (i) a subsequent display session; (ii) a subsequent sensory-reduced session; (iii) the first practice session; and (iv) a subsequent practice session.

15. The system of claim 14, where the controlling the playing of the audio content includes dynamically controlling playback speed of the audio content in the first practice session, such dynamic controlling being performed in real-time in response to electronic observation of the student's practice, and so as to maintain an audio-motion synchronization which is the same as that employed during the display of the model video example in the first display session.

16. The system of claim 15, where the controlling the playing of the audio content includes, during the first practice session, providing an audio indication when the student's performance deviates from a desired performance, as determined by the electronic observation.

17. The system of claim 15, where the controlling the playing of the audio content includes, during the first practice session, dynamically controlling playback speed of the audio content to induce the student to change the speed with which they are practicing the bodily motion, in response to determining via the electronic observation that the student is practicing at a non-desired speed.

18. The system of claim 14, where the controlling the playing of the audio content, during a first practice session in which the student practices the bodily motion, providing an audio indication when the student's performance deviates from a desired performance, as determined by the electronic observation.

19. The system of claim 14, where the electronic observation system includes an optical motion capture system.

20. The system of claim 14, where the electronic observation system includes wearable sensors affixed to the student's body.

21. The system of claim 12, further comprising an electronic observation system configured to electronically observe the student's practice of the bodily motion in a first practice session, the executable instructions being further operative to cause the output subsystem to display follow-up video content, the follow-up video content being different in at least one aspect from the model video example and generated in response to and based on electronic observation of the first practice session.

22. The method of claim 12, where output subsystem includes a head-mounted display incorporating the display device and the audio output device, and where the head-mounted display provides the displaying of the model video example in the first display session, and where the display device and the audio output device are used to provide the suppression of the sensory-reduced session.

23. A method for training a student to perform a bodily motion, comprising:
displaying a model video example of the bodily motion to the student in a first display session;
during the first display session, playing audio content that is associated with the model video example;
providing a first sensory-reduced session after the first display session, in which one or both of audio and visual stimulus perceivable by the student is suppressed;
playing the audio content during the sensory-reduced session, where the selection and playing of the audio content in the first display session and the sensory-reduced session are configured to induce the student to cognitively absorb the model video example;
electronically observing the student's practice of the bodily motion in a first practice session with an electronic observation system; and
in response to and based upon such electronic observation, controlling the playing of audio content during one or more of: (i) a second display session; (ii) a second sensory-reduced session; (iii) the first practice session; and (iv) a second practice session.

24. The method of claim 23, where the controlling the playing of audio content includes playing audio content that is at least partly different from the audio content that was played during the first display session and the first sensory-reduced session.

25. The method of claim 23, where the electronically observing includes determining that the student's practice deviates from a desired performance, and where the controlling the playing of audio content includes playing audio content that reflects the deviation.

26. The method of claim 23, where the electronically observing includes determining that the student's practice deviates from a desired performance, the method further comprising displaying video content that reflects the deviation.

27. The method of claim 23, where the displaying the model video example and the suppressing of stimulus are performed using a head-mounted display.
